(19) United States
(12) Patent Application Publication
(10) Pub. No.: US 2004/0097650 A1
(43) Pub. Date: May 20, 2004

(54) Thermoplastic elastomer composition and molded object thereof

(76) Inventors: Atsuko Ogawa, Rocklin, CA (US); Tadaaki Nishiyama, Ichihara-shi (JP); Hidetake Hozumi, Ichihara-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/469,850

(22) PCT Filed: Mar. 28, 2002
(86) PCT No.: PCT/JP02/03032

(30) Foreign Application Priority Data
Apr. 5, 2001 (JP) 2001-106902
Apr. 5, 2001 (JP) 2001-106904

(51) Int. Cl. C08L 53/00

(52) U.S. Cl. 525/98; 428/318.4; 428/319.3; 428/319.7; 428/319.9; 525/191; 525/240

(57) ABSTRACT

A thermoplastic elastomer composition comprising the following components (A) and (B), wherein a weight ratio of the component (A)/the component (B) is from 5/95 to 95/5:

(A): a thermoplastic resin, whose melt flow rate is 0.001 to 100 g/10 minutes, and whose die swell ratio is 1.7 to 5.0, and

(B): a hydrogenated vinyl aromatic compound-conjugated diene-based copolymer satisfied with all the following conditions (i) to (iii):

(i) a content of a vinyl aromatic compound unit is not more than 50% by weight,

(ii) a ratio of a hydrogenated conjugated diene unit having a side chain of 2 or more carbon atoms contained in the hydrogenated vinyl aromatic compound-conjugated diene-based copolymer to a total hydrogenated conjugated diene unit contained therein is not less than 60%, and

(iii) at least 80% of a double bond of a conjugated diene unit contained in the hydrogenated vinyl aromatic compound-conjugated diene-based copolymer is hydrogenated.

### TECHNICAL FIELD

The present invention relates to a thermoplastic elastomer composition, and a molded article obtained by using said thermoplastic elastomer composition. More specifically, the present invention relates to a thermoplastic elastomer composition, which is recyclable and can give an extrusion-molded article having superior processability, heat resistance, flexibility and resistance to whitening on bending; an extrusion-molded article, which is obtained by extrusion-molding said thermoplastic elastomer composition, and has the above-mentioned superior characteristics; and a multi-layer molded article, which has a cellular layer comprising said thermoplastic elastomer composition. Incidentally, in the present invention, “superior processability” means that a molded article under extrusion-molding has a superior shape retaining property, and an obtained extrusion-molded article scarcely has rough surface.

### BACKGROUND ART

An olefin-based thermoplastic elastomer has been used in place of a conventional rubber in many fields such as parts for automobiles, parts for domestic electric appliances, industrial parts and sundry goods. An example of the olefin-based thermoplastic elastomer is a thermoplastic elastomer comprising an ethylene-propylene-diene copolymer rubber and a polypropylene resin. However, said thermoplastic elastomer does not have completely satisfactory processability, heat resistance, flexibility and resistance to whitening on bending.

For interior parts for automobiles such as an instrument panel, a door trim, a console box, a lid and a pillar garnish, there has been used a molded article obtained by laminating a skin material, which comprises, for example, polyvinyl chloride or various kinds of thermoplastic elastomers, and various kinds of cellular materials typically exemplified by a polyurethane-based cellular material. In recent years, those interior parts for automobiles have been required to have more soft touch feeling in order to enhance their high-grade feeling. For example, JP-A-2000-177036 discloses an olefin-based thermoplastic elastomer composition for a flexible cellular material layer, which composition comprises a crystalline propylene-based copolymer, a low density polyethylene, an ethylene-propylene copolymer rubber and a blowing agent (expanding agent); and also discloses a multi-layer molded article produced by injection molding said composition between a flexible skin material and a rigid substrate. However, said multi-layer molded article does not have completely satisfactory touch feeling and light weight property.

### DISCLOSURE OF INVENTION

An object of the present invention is to provide a thermoplastic elastomer composition, which can give an extrusion-molded article having superior processability, heat resistance, flexibility and resistance to whitening on bending; and an extrusion-molded article thereof.

Further, another object of the present invention is to provide a multi-layer molded article, which has a cellular layer comprising said thermoplastic elastomer composition, and has superior touch feeling, light weight property, impact resilience, appearance, heat resistance and flexibility.

That is, the present invention relates to a thermoplastic elastomer composition comprising the following components (A) and (B), wherein a weight ratio of the component (A)/the component (B) is from 5/95 to 95/5; and relates to a molded article obtained by extrusion molding said thermoplastic elastomer composition:

(A): a thermoplastic resin, whose melt flow rate measured at 230° C. under a load of 2.16 kg according to JIS-K-7210 is 0.001 to 100 g/10 minutes, and whose die swell ratio by a capillary rheometer (measured according to JIS-K-7199 under conditions that temperature is 190° C.; a share rate is 122 sec⁻¹; capillary length is 10 mm; and a capillary diameter is 1 mm) is 1.7 to 5.0, and

(B): a hydrogenated vinyl aromatic compound-conjugated diene-based copolymer satisfying all the following conditions (i) to (iii):

(i) a content of a vinyl aromatic compound unit is not more than 50% by weight,

(ii) a ratio of a hydrogenated conjugated diene unit having a side chain of 2 or more carbon atoms contained in the hydrogenated vinyl aromatic compound-conjugated diene-based copolymer to a total hydrogenated conjugated diene unit contained therein is not less than 60%, and

(iii) at least 80% of a double bond of a conjugated diene unit contained in the hydrogenated vinyl aromatic compound-conjugated diene-based copolymer is hydrogenated.

The present invention also relates to a multi-layer molded article, which has a cellular layer comprising the above-mentioned thermoplastic elastomer composition.

### BRIEF DESCRIPTION OF DRAWINGS

FIG. 1 illustrates a non-cellular material and a core material arranged in advance in an injection compression molding method.

FIG. 2 illustrates supplying a molten thermoplastic elastomer composition into a cavity in an injection compression molding method.

FIG. 3 illustrates a process for producing a laminate by an injection compression molding method, which comprises the steps of packing a molten thermoplastic elastomer composition into a cavity, forming and expanding.

FIG. 4 illustrates a cavity-slide method in an injection compression molding method.

### EXPLANATION OF MARKS

1: female mold, 2: male mold, 3: passage for resin, 4: non-cellular material, 5: core material, 6: penetration hole, 7: cavity, 8: molten thermoplastic elastomer composition containing blowing agent, 9: multi-layer molded article comprising non-cellular layer/cellular layer/core material layer, 10: multi-layer molded article

### BEST MODE FOR CARRYING OUT THE INVENTION

The component (A) in the present invention is a thermoplastic resin, whose melt flow rate measured at 230° C. under a load of 2.16 kg is 0.001 to 100 g/10 minutes, and whose die swell ratio by a capillary rheometer (measured under conditions that temperature is 190° C.; a share rate is 122 sec⁻¹; capillary length is 10 mm; and a capillary diameter is 1 mm) is 1.7 to 5.0.

The melt flow rate of the component (A) is 0.001 to 100 g/10 minutes, preferably 0.01 to 50 g/10 minutes, and more preferably 0.1 to 20 g/10 minutes. When the melt flow rate is more than 100 g/10 minutes, an extrusion-molded article from the obtained thermoplastic elastomer composition may have an inferior shape retaining property; and in case of using as a cellular layer of a multi-layer molded article, appearance, touch feeling, blowing ability and impact resilience may be inferior in addition thereto. On the other hand, when the melt flow rate is less than 0.001 g/10 minutes, an extrusion-molded article from the obtained thermoplastic elastomer composition may have a rough surface; and in case of using as a cellular layer of a multi-layer molded article, appearance, touch feeling, blowing ability and impact resilience may be inferior.

The die swell ratio of the component (A) measured by a capillary rheometer is 1.7 to 5.0, preferably 1.8 to 4.5, and more preferably 2 to 4.0. When the die swell ratio is less than 1.7, an extrusion-molded article from the obtained thermoplastic elastomer composition may have an inferior shape retaining property. On the other hand, when the die swell ratio is more than 5.0, said extrusion-molded article may have a rough surface. Here, “die swell ratio” means a value obtained by dividing a diameter of a sample with a capillary diameter, wherein the sample means an extruded component (A) according to JIS-K-7199 under conditions of 190° C. (barrel temperature), capillary diameter of 1 mm, capillary length of 10 mm and share rate of 122 sec⁻¹.

The component (A) can be widely selected from various thermoplastic resins known in the art. Examples thereof are polyethylene-based resins such as a high density polyethylene, a medium density polyethylene, a low density polyethylene and a linear low density polyethylene (LLDPE); an ethylene-vinyl acetate copolymer resin; an ethylene-methyl methacrylate copolymer resin; an ethylene-methacrylic acid ester copolymer resin; an ethylene-acrylic acid ester copolymer resin; an ethylene-methacrylic acid copolymer resin; an ethylene-acrylic acid copolymer resin; an ethylene-styrene copolymer resin; a polypropylene-based resin; a polybutene-based resin; a poly-4-methyl-1-pentene-based resin; a polystyrene-based resin; a polyester-based resin; a polyamide-based resin; a polyphenylene ether-based resin; a polyacetal-based resin; a polycarbonate-based resin; a homopolymer resin of a cyclic olefin; and a copolymer resin of a cyclic olefin. Among them, preferable is a polyolefin-based resin; more preferable is a polyolefin-based resin containing, as a main component, an aliphatic olefin unit having 2 or more carbon atoms; further preferable is a polyolefin-based resin containing, as a main component, an aliphatic olefin unit having 3 or more carbon atoms; and particularly preferable is a polypropylene-based resin.

As the polypropylene-based resin, those having various structures can be used, such as a homo-type resin, a random-type resin comprising a comonomer and a block-type resin produced by a multi-step polymerization, which are crystalline polypropylene having mainly an isotactic or syndiotactic structure. Said polypropylene-based resin can be produced by a gas phase polymerization method, a bulk polymerization method, a solution polymerization method, or a multi-step polymerization method which is a combined method of two or more of the former three methods.

The polypropylene-based resin has a melting point of preferably 80 to 176° C., and more preferably 120 to 176° C.; and crystal melting calorie of preferably 30 to 120 J/g, and more preferably 60 to 120 J/g, from a viewpoint of enhancing heat resistance of a molded article obtained. Here, the melting point and the crystal melting calorie are measured according to JIS-K-7121 and JIS-K-7122, respectively.

The polypropylene-based resin is generally produced, for example, by a process comprising the step of one-step or multi-step homopolymerizing propylene to obtain a homopolymer, or one-step or multi-step copolymerizing propylene and at least one olefin selected from olefins having 2 to 12 carbon atoms other than propylene to obtain a copolymer, using a Ziegler Natta type catalyst using a combination of a so-called titanium-containing solid catalyst component with an organometal component, or a metallocene catalyst containing, as an essential component, a compound (which has at least one cyclopentadienyl skeleton) of a transition metal belonging to Groups 4 to 6 of a periodic table, by a polymerization method such as a slurry polymerization method, a gas phase polymerization method, a bulk polymerization method, a solution polymerization method and a combined polymerization method thereof. Further, it is possible to carry out a combination of homopolymerization and copolymerization in a multi-step polymerization method. A commercially available resin can be used.

Examples of the polypropylene-based resin satisfying requirements for the component (A) are those disclosed in JP-A-11-228629, JP-A-7-138430 or WO99/16797.

The component (B) in the present invention is a hydrogenated vinyl aromatic compound-conjugated diene-based copolymer satisfying all the following conditions (i) to (iii):

(i) a content of a vinyl aromatic compound unit is not more than 50% by weight,

(ii) a ratio of a hydrogenated conjugated diene unit having a side chain of 2 or more carbon atoms contained in the hydrogenated vinyl aromatic compound-conjugated diene-based copolymer to a total hydrogenated conjugated diene unit contained therein is not less than 60%, and

(iii) at least 80% of a double bond of a conjugated diene unit contained in the hydrogenated vinyl aromatic compound-conjugated diene-based copolymer is hydrogenated.

Examples of the component (B) are hydrogenated products of copolymers such as a block copolymer comprising a polymer block of a vinyl aromatic compound and a polymer block of a conjugated diene; and a block copolymer comprising a taper-like block, which contains a polymer block of a conjugated diene and a copolymer of a vinyl aromatic compound and a conjugated diene, in which copolymer a proportion of the vinyl aromatic compound increases gradually along its polymer chain. Numbers of a polymer block in said block polymers are 2 or more, and preferably 3 or 4, from a viewpoint of strength of an obtained thermoplastic elastomer composition and industrial productivity. Further, these are used singly or in combination of two or more thereof.

The component (B) may be modified by a functional group, and there can be used a functional group-modified material having at least one functional group selected from an acid anhydride group, a carboxyl group, a hydroxyl group, an amino group, an isocyanate group and an epoxy group.

Here, examples of the conjugated diene used for the component (B) are 1,3-butadiene, isoprene, 2,3-dimethyl-1,3-butadiene, 1,3-pentadiene, 2-methyl-1,3-pentadiene, 1,3-hexadiene, 4,5-diethyl-1,3-octadiene, 3-butyl-1,3-octadiene and chloroprene; and from a viewpoint of industrial productivity, 1,3-butadiene, isoprene or 1,3-pentadiene is preferable, and 1,3-butadiene or isoprene is particularly preferable.

Examples of the vinyl aromatic compound are styrene, α-methylstyrene, p-methylstyrene, t-butylstyrene, divinylbenzene, N,N-dimethyl-p-aminoethylstyrene, N,N-diethyl-p-aminoethylstyrene and vinylpyridine; and, from a viewpoint of industrial productivity, styrene or α-methylstyrene is preferable.

Among these component (B), a hydrogenated product of a styrene-butadiene-styrene block copolymer, a hydrogenated product of a styrene-isoprene-styrene block copolymer, a hydrogenated product of a styrene-butadiene•isoprene-styrene block copolymer, a hydrogenated product of a styrene-butadiene•styrene-styrene block copolymer or a hydrogenated product of a styrene-isoprene•styrene-styrene block copolymer is preferably used from a viewpoint of strength and industrial productivity of an obtained multilayer molded article. Here, “-” means a boundary of respective polymer blocks, and “•” means that respective monomers copolymerize in the block.

A content of the vinyl aromatic compound unit in the component (B) is not more than 50% by weight, preferably 5 to 25% by weight, and further preferably 10 to 20% by weight. When said content is more than 5% by weight, hardness of an obtained thermoplastic elastomer composition may be increased, and therefore, touch feeling and scratch resistance of an obtained molded article may be inferior. Also, flexibility, appearance, touch feeling, blowing ability and impact resilience of a cellular layer of a multi-layer molded article may be inferior.

A ratio of a hydrogenated conjugated diene unit having a side chain of 2 or more carbon atoms contained in the component (B) to a total hydrogenated conjugated diene unit contained therein is not less than 60%, preferably not less than 70%, and further preferably not less than 80%. When said ratio is less than 60%, hardness of a thermoplastic elastomer composition may be increased, and therefore, scratch resistance, impact resistance and resistance to whitening on bending of an obtained molded article may be inferior. Also, appearance, touch feeling, blowing ability, impact resilience and impact resistance of a cellular layer of a multi-layer molded article may be inferior.

At least 80%, preferably at least 90%, and further preferably at least 95% of a double bond of a conjugated diene unit contained in the component (B) is hydrogenated. When said hydrogenation degree is less than 80%, heat resistance and light resistance of a molded article comprising a thermoplastic elastomer composition may be inferior. Incidentally, the hydrogenation degree means a proportion of a total hydrogenated conjugated diene unit contained in the component (B), provided that a sum of the total hydrogenated conjugated diene unit therein and a total non-hydrogenated conjugated diene unit therein is 100%. Further, appearance, touch feeling, blowing ability, impact resilience and impact resistance of a cellular layer of a multi-layer molded article may be inferior.

The component (B) can be produced, for example, by a method disclosed in JP-A-3-72512, JP-A-5-271325 or JP-A-5-271327. Particularly, when the component (B) satisfies requirements disclosed in JP-A-2001-49051, even if a molded article comprising a thermoplastic elastomer composition is heated at 80 to 120° C., said molded article does not have a problem of gloss on its surface; and further, balance among various physical properties such as scratch resistance and flexibility is preferably superior.

The thermoplastic elastomer composition in accordance with the present invention contains the component (A) and the component (B) in a weight ratio, component (A)/component (B), of 5/95 to 95/5, preferably 10/90 to 90/10, further preferably 15/85 to 80/20, more preferably 15/85 to 55/45, particularly preferably 15/85 to 45/55. When a ratio of the component (A) exceeds 95/5, flexibility of a molded article molded using an obtained thermoplastic elastomer composition may be inferior; and on the other hand, when a ratio of the component (A) is less than 5/95, heat resistance and shape retaining property may be inferior, and an extrusion-molded article may have rough surface.

The thermoplastic elastomer composition in accordance with the present invention can be blended, in addition to the components (A) and (B), with other components such as thermoplastic resins, which do not satisfy the requirements for the component (A) and the component (B), and other resins. For example, there can be suitably blended thermoplastic resins not-satisfying the requirements for the component (A), and components such as a hydrogenated vinyl aromatic compound-conjugated diene-based copolymer not-satisfying the requirements for the component (B), a vinyl aromatic compound-conjugated diene-based copolymer, an ethylene-α-olefin copolymer rubber, an ethylene-α-olefin-polyene-based copolymer rubber, a propylene-α-olefin copolymer rubber, a natural rubber, polybutadiene, a liquid polybutadiene, a polyacrylonitrile rubber, a acrylonitrile-butadiene copolymer rubber, a hydrogenated acrylonitrile-butadiene copolymer rubber, a butyl rubber, a chloroprene rubber, a fluororubber, a chlorosulfonated polyethylene, a silicone rubber, an urethane rubber, an isobutylene-isoprene copolymer rubber, a halogenated isobutylene-isoprene copolymer rubber, a polyolefin-based thermoplastic elastomer, a polyurethane-based thermoplastic elastomer, a polyester-based thermoplastic elastomer, a polyamide-based thermoplastic elastomer, a 1,2-polybutadiene-based thermoplastic elastomer, a polyvinyl chloride-based thermoplastic elastomer, a transpolyisoprene-based thermoplastic elastomer and a chlorinated polyethylene-based thermoplastic elastomer.

The vinyl aromatic compound-conjugated diene-based copolymer is a copolymer obtained by copolymerizing the above-mentioned vinyl aromatic compound, conjugated diene and, if necessary, other components. Examples of the vinyl aromatic compound-conjugated diene-based copolymer are a styrene-butadiene block copolymer, a styrene-isoprene block copolymer, a styrene-butadiene-styrene block copolymer, a styrene-isoprene-styrene block copolymer, a styrene•butadiene random copolymer and a styrene-isoprene random copolymer.

The thermoplastic elastomer composition in accordance with the present invention can contain, in addition to the components (A) and (B), the following components (C) and/or (D):

(C): a polyethylene-based resin having a die swell ratio of less than 1.7, and

(D): a hydrogenated vinyl aromatic compound-conjugated diene-based copolymer other than the above-mentioned component (B).

When the thermoplastic elastomer composition in accordance with the present invention contains the above-mentioned components (C) and/or (D), a content thereof is preferably 0.1 to 500 parts by weight, further preferably 10 to 300 parts by weight, and particularly preferably 20 to 200 parts by weight, provided that a sum of the components (A) and (B) is 100 parts by weight.

Examples of the component (C) are a high density polyethylene, a medium density polyethylene, a low density polyethylene, a linear low density polyethylene (LLDPE), an ethylene-vinyl acetate copolymer resin, an ethylene-methyl methacrylate copolymer resin, an ethylene-methacrylic acid ester copolymer resin, an ethylene-acrylic acid ester copolymer resin, an ethylene-methacrylic acid copolymer resin, an ethylene-acrylic acid copolymer resin and an ethylene-styrene copolymer resin. These are used singly or in combination of two or more thereof.

An obtained thermoplastic elastomer composition containing the component (C) within the above-mentioned range has an improved impact resistance at lower temperature.

The component (D) is a hydrogenated vinyl aromatic compound-conjugated diene-based copolymer other than the above-mentioned component (B). Here, monomers such as a vinyl aromatic compound and a conjugated diene similar to those mentioned above are used. Also, a structure of said copolymer is similar to that mentioned above.

Examples of the component (D) are a hydrogenated vinyl aromatic compound-conjugated diene-based copolymer, which satisfies the above-mentioned conditions (i) and (ii) but does not satisfy the above-mentioned condition (iii); a hydrogenated vinyl aromatic compound-conjugated diene-based copolymer, which satisfies the above-mentioned conditions (i) and (iii) but does not satisfy the above-mentioned condition (ii); a hydrogenated vinyl aromatic compound-conjugated diene-based copolymer, which satisfies the above-mentioned conditions (ii) and (iii) but does not satisfy the above-mentioned condition (i); a hydrogenated vinyl aromatic compound-conjugated diene-based copolymer, which satisfies the above-mentioned condition (i) but does not satisfy the above-mentioned conditions (ii) and (iii); and a hydrogenated vinyl aromatic compound-conjugated diene-based copolymer, which does not satisfy all the above-mentioned conditions (i) to (iii).

For example, when a hydrogenated vinyl aromatic compound-conjugated diene-based copolymer, which satisfies the above-mentioned conditions (i) and (iii) but does not satisfy the above-mentioned condition (ii) is used, an obtained thermoplastic elastomer composition containing the component (D) within the above-mentioned range has improved physical properties such as tensile strength and impact resistance at lower temperature.

Further, the thermoplastic elastomer composition in accordance with the present invention can be blended, in addition to the components (A) and (B), with other components such as an adhesive resin component and various additional components.

As the adhesive resin component, resins such as a rosin-based resin, a polyterpene-based resin, a synthetic petroleum resin, a cumarone-based resin, a phenol-based resin, a xylene-based resin, a styrene-based resin and an isoprene-based resin can be suitably blended. Examples of the rosin-based resin are a natural rosin; a polymerized rosin; a partially or completely hydrogenated rosin; an esterified compound such as a glycerine ester of these various rosins, a pentaerythritol ester thereof, an ethylene glycol ester thereof and a methyl ester thereof; and rosin derivatives such as a disproportionation resin, a fumaric acid-modified resin, a lime-modified resin, or a suitable combination thereof.

Examples of the polyterpene-based resin are a homopolymer and a copolymer of a cyclic terpene such as α-pinene, β-pinene and dipentene; a terpene-phenol-based resin (for example, an α-pinene-phenol resin, a dipentene-phenol resin and a terpene-bisphenol resin), which is a copolymer of terpene such as α-pinene, β-pinene and dipentene and a phenol-based compound such as phenol and bisphenol; and an aromatic modified terpene resin, which is a copolymer of terpene such as α-pinene, β-pinene and dipentene and an aromatic monomer.

Examples of the synthetic petroleum resin are a homopolymer and a copolymer of a C₅ fraction, C₆ to C₁₁ fractions and other olefin-based fractions of naphtha cracked oil; hydrogenated products of these polymers (such as an aliphatic-based petroleum resin, an aromatic-based petroleum resin, an alicyclic-based petroleum resin, and an aliphatic-alicyclic copolymer resin). Further, there are exemplified a copolymer-based petroleum resin such as a copolymer of respective fractions of the above-mentioned naphtha cracked oil and the above-mentioned various terpenes, and hydrogenated products thereof. Here, as the C₅ fraction of the naphtha cracked oil, methylbutenes such as isoprene, cyclopentadiene, 1,3-pentadiene, 2-methyl-1-butene and 2-methyl-2-butene; pentenes such as 1-pentene and 2-pentene; or dicyclopentadiene are preferable. As the C₆ to C₁₁ fractions, methylstyrenes such as indene, styrene, o-, m- and p-vinyltoluene, α- and β-methylstyrene; methylindene; ethylindene; vinylxylene or propenylbenzene are preferable. As other olefin-based fractions, butene, hexene, heptene, octene, butadiene or octadiene is preferable.

Examples of the phenol-based resin are an alkylphenol resin, an alkylphenol-acetylene resin obtained by condensation between an alkylphenol and acetylene, and modified products of such resins. Here, the phenol-based resin may be either a novolak-type resin obtained by methylolation of phenol with an acid catalyst, or a resol-type resin obtained by methylolation thereof with an alkaline catalyst.

Examples of the xylene-based resin are a xylene-formaldehyde resin obtained from m-xylene and formaldehyde, and a modified resin thereof obtained by reaction with a third component.

Examples of the styrene-based resin are a lower molecular weight product of polystyrene, a copolymer resin of α-methylstyrene and vinyltoluene, and a copolymer resin of styrene, acrylonitrile and indene.

An example of the isoprene-based resin is a resin obtained by copolymerizing a C₁₀ alicyclic compound, which is a dimer of isoprene, and a C₁₀ chain compound.

Among the above-mentioned adhesive resin components, the rosin-based resins, polyterpene-based resins or synthetic petroleum resins are preferable. Of these, those having an aliphatic and/or alicyclic structure are more preferable from a viewpoint of transparency of a molded article molded using the obtained thermoplastic resin composition. Here, as a particularly preferable adhesiveness-giving resin having an aliphatic and/or an alicyclic structure, with respect to the rosin-based resin, partially or completely hydrogenated rosin and a derivative thereof; with respect to the polyterpene-based resin, a homopolymer or copolymer of a cyclic terpene; and with respect to the synthetic petroleum resin, an aliphatic-based petroleum resin, an alicyclic-based petroleum resin, an aliphatic-alicyclic copolymer resin and a copolymer of a hydrogenated product of naphtha cracked oil and various terpenes are exemplified. These resin components are used singly or in a mixture of two or more. By the way, as the resin component, a corresponding commercially available resin can be used.

Various additional components such as additives, fillers, softening agents, fire retardants, high-frequency processing coagents, fillers giving a brilliant appearance, nucleating agents, plasticizers, anti-bacterial agents and blowing agents can be suitably blended.

Examples of the additives are age resistors, antioxidants, antiozonants, ultraviolet absorbers and light-stabilizers. Also, There are exemplified antistatic agents, slip agents, internal stripping agents, coloring agents, dispersants, anti-blocking agents, lubricants and anti-fogging agents. Examples of the fillers are glass fiber, carbon fiber, metal fiber, glass beads, asbestos, mica, calcium carbonate, potassium titanate whisker, talc, aramid fiber, barium sulfate, glass flakes and fluororesin.

An example of the softening agent is a mineral oil-based softening agent such as naphthene oil and paraffin-based mineral oil.

Examples of the fire retardants are inorganic compounds such as antimony-based fire retardants, aluminum hydroxide, magnesium hydroxide, zinc borate, guanidine-based fire retardants and zirconium-based fire retardants; phosphates and phosphorus compounds such as ammonium polyphosphate, ethylenebistris(2-cyanoethyl)phosphonium chloride, tris(tribromophenyl)phosphate, tris(tribromophenyl)phosphate, and tris(3-hydroxypropyl)phosphinoxide; chlorine-containing fire retardants such as a chlorinated paraffin, a chlorinated polyolefin and perchlorocyclopentadecane; bromine-containing fire retardants such as hexabromobenzene, ethylenebisdibromonorbornane dicarboxyimide, ethylenebistetrabromophthalimide, tetrabromobisphenol-A derivatives, tetrabromobisphenol S and tetrabromodipentaerythritol; and a mixture thereof.

As the high-frequency processing coagents, for example, polar polymer can be added. Specific examples thereof are copolymers of ethylene and one or more comonomer(s) selected from unsaturated monocarboxylic acids such as acrylic acid, methacrylic acid, ethacrylic acid and crotonic acid; unsaturated dicarboxylic acids such as maleic acid, fumaric acid, itaconic acid and citraconic acid; esters of unsaturated carboxylic acid such as methyl methacrylate, methyl acrylate and ethyl acrylate; ionomers of unsaturated carboxylic acids; and vinyl esters of saturated carboxylic acids such as vinyl acetate and vinyl propionate.

The thermoplastic elastomer composition in accordance with the present invention can be produced by mixing the components (A) and (B) and, if necessary, other components using a known apparatus such as a Bambury mixer, an extruder, a roll and a pressure kneader. Also, as the thermoplastic elastomer composition, there can be used, if necessary, a partially crosslinked type thermoplastic elastomer composition, which has been crosslinked by, for example, sulfur crosslinking and organic peroxide crosslinking known in the art. Among them, a dynamically crosslinking method using a crosslinking agent such as an organic peroxide, and a crosslinking coagent such as bismaleimide and divinylbenzene is preferably used.

Although the above-mentioned mixing apparatus may be either a closed type or open type apparatus, it is preferable to use a closed type apparatus capable of being purged with an inert gas. A mixing temperature is a temperature at which all the components mixed are melted, and usually from 70 to 400° C., preferably from 100 to 300° C., and more preferably from 150 to 270° C. A kneading time depends upon kinds and amounts of the components mixed and a kind of the kneading apparatus. It is usually from about 0.5 to 60 minutes, preferably from 1 to 30 minutes, and more preferably from 3 to 10 minutes, when using a mixing apparatus such as a pressure kneader and a Bambury mixer. Incidentally, the mixing step can be carried out either by mixing respective components at a time, or by a multi-stage divided kneading method, wherein a part of the components are mixed, then, the remaining components are added, and thereafter mixing is continued.

The thermoplastic elastomer composition in accordance with the present invention is particularly superior as a material for extrusion-molding; and an extrusion-molded article can be obtained by melt-extruding from an extruder, then cooling and thereafter cutting, wherein a mold having a shape of said article is attached to the extruder's end.

Further, the thermoplastic elastomer composition in accordance with the present invention is also superior as a material for calender molding, and a calender molded article can be obtained by a sheeting process for continuous production of a flat sheet having a high thickness accuracy; a doubling process for continuous production of a sheet of the same or different kind of thermoplastic elastomer compositions or different kind of thermoplastic resin compositions, which sheet has a high thickness accuracy and no pinhole; a topping process for continuous production of a complex by combining cloth or something like that with a sheet; a friction process wherein a thermoplastic elastomer composition is rubbed in cloth to improve adhesion of the cloth; or a profiling process wherein an engraved pattern is made on a roll surface, and said pattern is transcribed continuously on a sheet surface.

Further, the thermoplastic elastomer composition in accordance with the present invention is superior as a material for blow molding; and a blow-molded article can be obtained by various methods such as, besides a conventional blow molding, a sheet parison method, a cold parison method, a bottle pack method, an injection blow molding method and a stretching blow molding method. In this blow molding step, it is preferable to blow mold an obtained thermoplastic elastomer composition using a parison or a sheet of not lower than 200° C. from a viewpoint of a blow-up property and surface appearance. Still further, for the purpose of obtaining better effects, it is permitted to use an inert gas such as nitrogen, carbon dioxide, helium, argon and neon in place of air when expanding a parison or a sheet.

Furthermore, the thermoplastic elastomer composition in accordance with the present invention is also superior as a material for expansion molding; and various expansion molded articles can be obtained by, for example, injection molding, extrusion molding or injection blow molding. Still further, when producing molded articles such as expanded tube-like articles, plate-like articles and stick-like articles having a large thickness by extrusion molding, it is preferable to cool an expansion molded article to be extruded through a cooling mandrel from a viewpoint of dimension accuracy.

Additionally, the thermoplastic elastomer composition in accordance with the present invention is also superior as a material for stretch-molding; and various stretch-molded articles can be obtained by, for example, uniaxial stretching, successive biaxial stretching or simultaneous biaxial stretching.

Further, the thermoplastic elastomer composition in accordance with the present invention gives a multi-layer molded article comprising an expanded layer with excellent properties. A structure of said expanded layer is explained as follows.

Examples of a molding method for molding an expanded article having a desired shape from the thermoplastic elastomer composition in accordance with the present invention and a blowing agent are extrusion molding, injection molding (such as low-pressure injection molding and injection compression molding), powder molding and internal mold expansion molding.

A blowing agent is not particularly limited. For example, a chemical blowing agent represented by sodium hydrogen carbonate and azodicarbonamide; and a physical blowing agent represented by carbon dioxide, nitrogen gas and butane can be used; and a combination thereof can be used. Also, it is possible to add inorganic fillers such as talc and silica as a bubble nucleating agent.

Examples of the chemical blowing agent as a thermal decomposition-type agent, which decomposes thermally to generate gas, are azodicarbonamide, oxybenzenesulfonyl hydrazide, azobisisobutyronitrile, barium azodicarboxylate and hydrazodicarbonamide. In order to obtain an expanded article having uniform cells, it is preferable to adjust a decomposition temperature of the blowing agent nearly to a melt temperature of the thermoplastic elastomer composition, and it is permitted to add a blowing coagent to regulate a decomposition temperature of the blowing agent. Also, in order to prevent generation of non-uniform cells caused by generation of heat due to decomposition of the chemical blowing agent, it is permitted to use a combination thereof with a blowing agent, which shows endothermic decomposition behavior.

An amount of the chemical blowing agent added is not particularly limited as far as it generates a necessary amount of gas; and, from a viewpoint of impact resilience, touch feeling, light weight property, appearance, flexibility and strength, it is generally from 0.1 to 10 parts by weight, and preferably from 0.5 to 5 parts by weight per 100 parts by weight of the thermoplastic elastomer composition.

The chemical blowing agent and the thermoplastic elastomer composition are blended preferably homogeneously. An example of a mixing method is a mechanically mixing method using a mixing machine such as a tumbler mixer and a Henschel mixer. The thermoplastic elastomer composition prior to blending with the chemical blowing agent may be melt-kneaded in advance using, for example, an extruder. Further, when the components (A) and (B) constituting the thermoplastic elastomer composition and an optionally added component have a pellet-like or powder-like form, a mixture of these components and the chemical blowing agent mechanically mixed by the above-mentioned method may be used. Also, it is permitted to melt-knead the components (A) and (B), an optionally added component and the chemical blowing agent at a temperature of not higher than a decomposition temperature of the chemical blowing agent.

As a physical blowing agent, an inert gas such as nitrogen gas and carbon dioxide is generally used. It is permitted to use a combination of the chemical blowing agent and the physical blowing agent.

A blowing agent may be used, if necessary, in combination with a blowing coagent. Examples of the blowing coagent are zinc oxide, zinc nitrate, basic zinc carbonate, zinc stearate, zinc phthalate, lead carbonate, urea and glycerine. Also, it is preferable to use a combination thereof with powder such as calcium carbonate, talc and silica as a bubble nucleating agent.

Particularly, when producing a multi-layer molded article by a process comprising the steps of producing a cellular material containing the above-mentioned thermoplastic elastomer composition using an extrusion molding method, and thereafter, producing a multi-layer molded article by adhering using an adhesive the below-mentioned non-cellular material and a cellular material, it is preferable to use a mixed gas of nitrogen gas and carbon dioxide as a blowing gas from a viewpoint of obtaining an expansion molded article having a fine cell diameter; and in this case, for example, it is possible to use a method, wherein admixed gas of nitrogen gas and carbon dioxide is fed under pressure directly into an extruder, and further, it is possible to use a combination of a thermal decomposition-type blowing agent, which decomposes to generate mainly nitrogen gas, and a thermal decomposition-type blowing agent, which decomposes to generate mainly carbon dioxide.

Here, as the thermal decomposition-type blowing agent generating mainly nitrogen gas, there can be exemplified azodicarbonamide, azobisisobutyronitrile, dinitrosopentamethylenetetramine, p-toluenesulfonyl hydrazide and p,p′-oxy-bis(benzenesulfonyl hydrazide); and azodicarbonamide is preferably used. Incidentally, these blowing agents may be used in a combination thereof.

As the thermal decomposition-type blowing agent generating mainly carbon dioxide, there can be exemplified sodium hydrogen carbonate, ammonium carbonate and ammonium hydrogen carbonate; and sodium hydrogen carbonate is preferably used. Incidentally, these blowing agents may be used in a combination thereof.

When a combination of the thermal decomposition-type blowing agent generating mainly nitrogen gas with the thermal decomposition-type blowing agent generating mainly carbon dioxide is used, a weight ratio of the former blowing agent to the latter blowing agent is from 1/99 to 30/70, preferably from 1/99 to 20/80, and more preferably from 1/99 to 10/90, from a viewpoint of fineness and uniformity of a cell diameter.

When a mixed gas of nitrogen gas and carbon dioxide is used as a blowing agent, a volume ratio of nitrogen gas to carbon dioxide is from 1/99 to 30/70, preferably from 1/99 to 20/80, and more preferably from 1/99 to 10/90. In this case, it is preferable to use powder such as calcium carbonate, talc and silica as a bubble nucleating agent.

When producing a cellular material using an extrusion-molding method, there is applied a process comprising the steps of feeding a mixture of the above-mentioned thermoplastic elastomer composition and a blowing agent to an inlet for feeding raw materials; fusing the thermoplastic elastomer composition and generating gas in the extruder; kneading sufficiently the molten thermoplastic elastomer composition and the gas, and unifying them; cooling the unified mixture to a suitable temperature for expanding; extruding the mixture through a die, and expanding it; and cooling with a taking-off machine.

An extruder used for producing a cellular material according to an extrusion-molding method is not particularly limited; and preferable is at least such an extruder that the thermoplastic elastomer composition and the gas are kneaded and unified sufficiently, and the resultant mixture is cooled and regulated to a suitable temperature for expanding. As such an extruder, there can be exemplified a uniaxial extruder and a multiaxial extruder. As the multiaxial extruder, a biaxial extruder is generally used, two screws of which extruder may have either the same rotating direction or different rotating directions. The biaxial extruder may be either an extruder, screws of which extruder have a constant diameter and are arranged in parallel with each other, or an extruder, screws of which extruder have a small diameter at their ends and are arranged in oblique with each other. In case of a biaxial extruder, since a blowing gas easily leaks out of a hopper, it is preferable to provide its screws with a sealing segment. A uniaxial extruder is preferably used from a viewpoint that a blowing gas hardly leaks out of a hopper and its cost is low. Also, it is possible to use a tandem extruder, which is a combination of a uniaxial extruder and a multiaxial extruder. As the die of an extruder, either a flat die or a circular die can be used; and it is possible to control thickness of a cellular layer by regulating a lip-gap at an end of a die.

When also producing a cellular material according to an injection-molding method (such as a low-pressure injection-molding method and an injection-compression molding method) using a pair of a male mold and a female mold, the thermoplastic elastomer composition in accordance with the present invention and a chemical blowing agent and/or a physical blowing agent are melt-kneaded and unified in a supplying cylinder similarly to an extrusion-molding method. A cellular material can be produced by a process comprising the steps of supplying said blowing agent-containing molten thermoplastic elastomer composition, which has been melt-kneaded and unified, into a mold cavity constituted by a pair of a core mold and a cavity mold; forming it, if necessary; and thereafter, cooling and solidifying it in a mold.

Further, the thermoplastic elastomer composition in accordance with the present invention can be used either as a single-layer or as a multi-layer molded article having two or more layers, any of which layers contains the thermoplastic elastomer composition in accordance with the present invention. Examples of a constitution of the multi-layer molded article are non-cellular layer/cellular layer, non-cellular layer/cellular layer/non-cellular layer, cellular layer/non-cellular layer/cellular layer and non-cellular layer/cellular layer/non-cellular layer/cellular layer. Here, the thermoplastic elastomer composition in accordance with the present invention can also be used as a non-cellular layer; and when two or more layers containing the thermoplastic elastomer composition in accordance with the present invention exist, respective contents of the components (A) and (B) constituting the thermoplastic elastomer composition and other components selected if necessary may be either the same or different from each other. Also, a multi-layer molded article may contain a layer comprising various polymers other than the thermoplastic elastomer composition in accordance with the present invention; and examples thereof are a multi-layer molded article, wherein a cellular layer comprising the thermoplastic elastomer composition in accordance with the present invention and a core material are laminated; and a multi-layer molded article, wherein a core material is further laminated on a cellular layer of a pre-produced multi-layer molded article, which contains a non-cellular layer comprising the thermoplastic elastomer composition in accordance with the present invention and a cellular layer.

An expansion ratio of a cellular layer of a multi-layer molded article can be enhanced by using the thermoplastic elastomer composition in accordance with the present invention; and therefore, there can be obtained a multi-layer molded article having a superior touch feeling and impact resilience and a superior expansion property. Additionally, in case of a multi-layer molded article having a non-cellular layer comprising the thermoplastic elastomer composition in accordance with the present invention, there can be obtained a multi-layer molded article having superior various physical properties such as scratch resistance, abrasion resistance and impact resistance. A surface of said non-cellular layer may often has a pattern such as an embossed pattern and a stitched pattern; and in this case, there can be produced a multi-layer molded article having superior design.

Thickness of a cellular layer in a multi-layer molded article is preferably from 1 to 10 mm, and more preferably from 2 to 8 mm from a viewpoint of enhancing sense of touch, impact resilience and strength. And, thickness of a non-cellular layer in a multi-layer molded article is preferably from 0.1 to 2 mm, and more preferably from 0.5 to 1.2 mm from a viewpoint of enhancing penetrating strength and flexibility.

When the thermoplastic elastomer composition in accordance with the present invention is used for a cellular layer in a multi-layer molded article, its expansion ratio is preferably from 2.7 to 6.0 times, more preferably from 3.0 to 5.5 times, and further preferably from 3.5 to 5.0 times from a viewpoint of enhancing touch feeling, light weight property, impact resilience and strength.

A multi-layer molded article is produced by a molding method known in the art. For example, it can be produced by the following methods.

### (1) Production of Multi-Layer Molded Article Comprising Non-Cellular Layer/Cellular Layer

A multi-layer molded article comprising a non-cellular layer/cellular layer can be produced by \mathring{1} an adhesion method or a thermal melt-adhesion method or \mathring{2} a one-body production method.

As a material used for the non-cellular layer, there are generally used various polymers such as the thermoplastic elastomer composition in accordance with the present invention; a thermoplastic elastomer other than the thermoplastic elastomer composition in accordance with the present invention (for example, a polyolefin-based thermoplastic elastomer composition and a polyurethane-based thermoplastic elastomer); a polyvinyl chloride-based resin; and the above-mentioned polyolefin-based resins or their cross-linked products. Among them, in case of using a non-cellular layer as a skin layer of a multi-layer molded article, the thermoplastic elastomer composition in accordance with the present invention is preferable from a viewpoint of scratch resistance. Also, in case of using a polyolefin-based resin as the component (A), a polyolefin-based resin or its cross-linked product, or a polyolefin-based thermoplastic elastomer composition is preferable from a viewpoint of, for example, recyclablity. Incidentally, these polymers may be blended with, for example, pigments, various stabilizers or fillers.

### \mathring{1} Adhesion Method or Thermal Melt-Adhesion Method

The captioned method is a method comprising the steps of molding the thermoplastic elastomer composition in accordance with the present invention into a cellular material having a desired form, and thereafter, adhering a non-cellular material, which has been produced separately, using a conventional adhesive; or a method of consolidating by a thermal melt-adhesion method.

Examples of a method for molding the thermoplastic elastomer composition into a non-cellular material having a desired form are an extrusion molding method, an injection molding method, a compression molding method, a powder molding method and a vacuum forming method. Incidentally, in case of producing said non-cellular material by a powder molding method, an elastomer composition powder used for a powder molding, which powder is disclosed in, for example, JP-A-10-30036, JP-A-5-5050 and JP-A-2001-49052, is preferably used.

By the way, in an injection molding method (such as a low pressure injection molding method and an injection compression molding method), a cellular material having higher expansion ratio can be produced by a method (this method is hereinafter referred to as “cavity-slide method”) comprising the step of opening a core mold and/or a cavity mold to a pre-determined degree to expand a volume of a mold cavity, before an expanded thermoplastic elastomer composition, which has been supplied into the mold cavity and then formed, is cooled and solidified.

### \mathring{2} One-Body Production Method

A multi-layer molded article comprising a non-cellular layer/cellular layer comprising the thermoplastic elastomer composition in accordance with the present invention can be produced in one body manner, according to, for example, a coextrusion molding method, a two-layer injection molding method or a two-layer powder molding method. In this case, a multi-layer molded article is produced in a desired form such as a sheet-like form (in case of the two-layer powder molding method, a complicated form is also obtained) and a pipe-like form.

Additionally, it can also be produced by a method comprising the steps of molding a cellular material layer under a condition that a non-cellular material is arranged in a core mold and/or a cavity mold; and then consolidating the non-cellular material and the cellular material simultaneously with molding of the cellular material.

The multi-layer molded article produced by those methods can further be processed to an article having a desired form according to a vacuum forming method or by bending.

### (2) Production of Multi-Layer Molded Article Comprising Non-Cellular Layer/Cellular Layer/Core Material Layer

There can be used a multi-layer molded article, wherein a core material is further laminated on a cellular layer of a multi-layer molded article comprising non-cellular layer/cellular layer. As the core material, there is preferably used a resin having rigidity known in the art such as a polypropylene-based resin, a polyethylene-based resin, a polystyrene-based resin and an acrylonitrile-butadiene-styrene copolymer. By the way, thickness of a layer comprising a core material (core material layer) is generally from 1 to 20 mm, and preferably from 2 to 5 mm, from a viewpoint of enhancing strength of a multi-layer molded article, and from a viewpoint of flexibility. The core material may be a preformed cellular material, and in this case, a multi-layer molded article having a further superior light-weight property can be obtained.

As a method for producing a multi-layer molded article comprising a non-cellular layer/cellular layer/core material layer, there can be exemplified \mathring{1} an adhesion method or a thermal melt-adhesion method, \mathring{2} a method of supplying a molten resin used for a core material and forming it, and \mathring{3} a method of laminating and molding in one body.

### \mathring{1} Adhesion Method or Thermal Melt-Adhesion Method

There can be produced by a process comprising the steps of producing a two-layer molded article containing a non-cellular layer and a cellular layer, and thereafter, adhering a core material using a known adhesive or by a thermal melt-adhesion method; by a process comprising the steps of producing a two-layer molded article containing a cellular layer and a core material, and thereafter, adhering a non-cellular material by the above-mentioned method; or by a process comprising the step of adhering a non-cellular material, a cellular material and a core material using the present method.

### \mathring{2} Method of Supplying Molten Resin Used for Core Material and Forming It

There can be produced by a process comprising the steps of supplying a molten material for forming a core material to a cellular layer side of a multi-layer molded article containing a non-cellular layer/cellular layer according to an injection molding method (such as a low-pressure injection molding method and an injection compression molding method); then, forming, if necessary; and thereafter, consolidating simultaneously with forming a core material.

### \mathring{3} Method of Laminating and Molding in One Body

This method means specifically a method comprising the steps of arranging a preformed non-cellular material and a preformed core material in a cavity mold and a core mold, respectively, using an injection molding method (such as a low-pressure injection molding method and an injection-compression molding method) or a compression molding method and using a pair of a male mold and a female mold; then supplying a molten material containing a blowing agent between said non-cellular material and said core material; then forming, if necessary; then foaming; and thereafter, consolidating the non-cellular material, the cellular material and the core material simultaneously with forming a cellular material between said non-cellular material and said core material.

Further, in the method of laminating and molding in one body, there can be produced a multi-layer molded article having a cellular layer with a higher expansion ratio by a process (cavity-slide process) comprising the steps of supplying a molten material containing a blowing agent between the above-mentioned non-cellular material and core material; then forming, if necessary; and thereafter, opening a core mold and/or a cavity mold to a pre-determined degree before the molten material is cooled and solidified, thereby expanding a forming volume of a cellular material, which volume is made between said non-cellular material and core material.

In case of using a method of laminating and molding in one body other than a cavity-slide process, an expansion ratio of a cellular layer can mainly be regulated by an amount of a polymer containing a blowing agent, which polymer is supplied between a non-cellular layer and core material; and in case of the cavity-slide process, an expansion ratio can optionally be regulated further by an opening degree of said core mold and/or cavity mold. Also, as the blowing agent, the above-mentioned blowing agents can be used, and a blowing coagent and a bubble nucleating agent can be used in combination therewith.

Among these production methods, the adhesion method has a problem in a working environment due to use of a solvent; and a method of supplying and forming a molten resin used for a core material has a problem that a cellular layer is easily destroyed, when forming a core material, by an influence of heat and pressure. Accordingly, it is preferable to use a method of laminating and molding in one body.

The following is an example of a method comprising the steps of supplying a molten thermoplastic elastomer composition containing a blowing agent using an injection-compression molding method between a non-cellular material and core material; then foaming it; and thereafter laminating and consolidating the non-cellular layer/cellular layer/core material.

FIG. 1 illustrates a male mold 2 having a female mold 1 used for an injection-compression molding method and a path 3 for a molten resin. A pre-formed non-cellular material 4 is arranged in the female mold 1; and a pre-formed core material 5 having a penetrating hole 6 is also arranged at a corresponding position to that of the path 3 for a molten resin in the male mold 2.

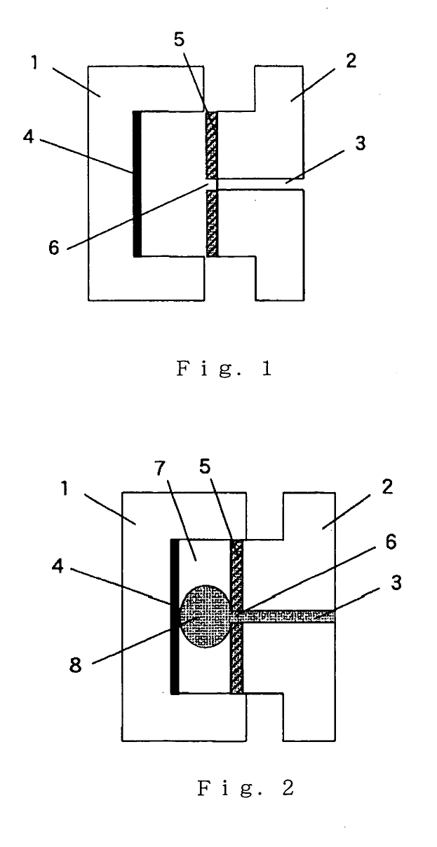

As shown in FIG. 2, after getting the male mold and the female mold close to a pre-determined position, a melt-kneaded molten thermoplastic elastomer composition 8 containing a blowing agent is supplied using a injection machine (not illustrated) into a cavity 7 formed by the non-cellular material 4 and the core material 5 from the penetrating hole 6 of the core material 5 through the path 3 of the male mold 2

A shape of the penetrating hole is not particularly limited as far as the molten thermoplastic elastomer composition containing a blowing agent is supplied into the cavity 7; and may be an optional shape such as a circular hole and a square hole. Although a size of the penetrating hole is not also particularly limited, it is preferably as small as possible, because a too large size hole deteriorates rigidity of the core material.

Temperature for melt-kneading the blowing agent and said thermoplastic elastomer composition in the injection machine is optionally setup depending upon, for example, a blowing agent used, and it is generally from 170 to 260° C.

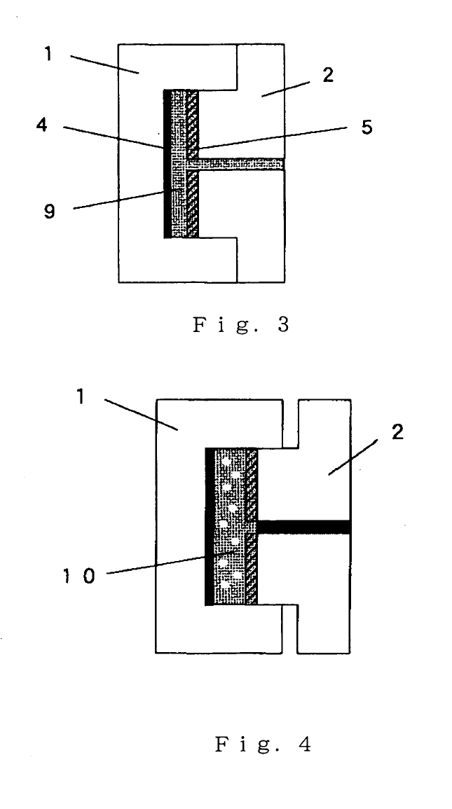

Next, after completion of supplying, or under supplying, the male mold 2 and/or the female mold 1 are moved and clamped; then the molten thermoplastic elastomer composition 8 containing a blowing agent is packed into the cavity 7 and formed; and said thermoplastic elastomer composition is expanded, and the non-cellular material 4 and the core material 5 are consolidated (FIG. 3). A forming pressure by this clamping is preferably as low as possible in order to expand more easily the expanded thermoplastic elastomer composition, and it is preferably 10 MPa or lower.

A multi-layer laminated material 9 comprising a non-cellular layer/cellular layer/core material is obtained by a process comprising the steps of laminating and consolidating; cooling in a mold; and thereafter opening the mold and taking out the multi-layer laminated material.

Additionally, FIG. 4 illustrates an example of a cavity-slide method; and a multi-layer laminated material 10 with a cellular layer having a higher expansion ratio can be obtained by a process comprising the steps of packing a molten thermoplastic elastomer composition 8 containing a blowing agent illustrated in FIG. 3 in the cavity 7, forming and expanding; laminating and consolidating the non-cellular material 4 and the core material 5; and thereafter opening the male mold 2 and/or the female mold 1 to a pre-determined degree before said expanded thermoplastic elastomer composition is cooled completely, thereby expanding a cavity volume.

A timing of opening a mold to a pre-determined degree may be anytime as far as a thermoplastic elastomer composition is in an expandable condition, and it is preferable to open a mold within 10 minutes after completion of forming, because too much cooling cannot give a high expansion ratio.

Further, it is also possible to produce a multi-layer molded article comprising a non-cellular layer/cellular layer containing the thermoplastic elastomer composition in accordance with the present invention/layer containing other material than a core material by using a sheet comprising other material than a core material in place of the above-mentioned core material. The sheet comprising other material than a core material may be either a sheet containing the thermoplastic elastomer composition in accordance with the present invention, or a different sheet.

Further, it is possible to give a leather embossed pattern or a stitched pattern onto a surface of a multi-layer molded article by giving in advance such a leather embossed pattern or a stitched pattern onto a product surface of a cavity mold or a core mold forming a non-cellular layer, and thereby it is possible to give a high-grade feeling to the multi-layer molded article.

The thermoplastic elastomer composition in accordance with the present invention can be molded to various molded articles; and it can be used, by utilizing its superior characteristics, for various uses such as parts for vehicles, parts for electric and electronic instruments, electric wires, building materials, goods for agriculture, marine product and gardening uses, goods for chemical industry use, public works materials, industry and manufacture materials, furniture, stationary goods, daily necessaries, miscellaneous goods, clothes, goods for vessel and package use, toys, goods for leisure use and goods for medical use. Examples of the parts for vehicles are car interior skins of such as instrumental panels, doors, pillars and air bag covers; car exterior parts such as over fenders, clouding panels, roof rails and side moldings; and bicycle parts. Examples of the parts for electric and electronic instruments are electric parts, electronic parts, light electric parts, materials for household appliances, goods for refrigerator use, lighting instruments and various covers for electric use. Examples of the electric wires are plastic cables, insulated wires and materials for protecting electric wires. Examples of building materials are materials for wall and ceiling uses such as ribs, baseboards, panels and tarpaulins; materials for roofing use such as corrugated boards, troughs and roof backing materials; materials for flooring use such as sill materials and tiles; materials for waterproof use such as jointing, jointing sticks and waterproof sheets; materials for equipment and apparatus uses such as ducts, cable ducts, prefablication materials and purifiers; materials for structuring and furnishing uses such as building edges, building gaskets, weights of carpet, angles and louvers; and materials for industrial uses such as joiners and curing sheets. Examples of the goods for agriculture, marine product and gardening uses are housing materials for agriculture. Examples of the industry and manufacture materials are machine covers, machine parts, packing, gaskets, hoses, flanges, leather sailing cloths, bolts, nuts, valves and metal-protecting films. Examples of furniture are cabinets, stools, sofas, mats, curtains and tablecloths. Examples of the stationary goods are card cases, cases for writing goods, accessories, key cases, cash card cases, stickers, labels, book covers, note covers, binders, pocket books, covers, files, cards, commutation tickets, desk pads, holders, magazine trays, albums, templates and grips of writing goods. Examples of the daily necessaries and miscellaneous goods are bath covers, drainboards, buckets, dress covers, bedding cases, Western umbrellas, umbrella covers, reed screens, sewing requisites, shelf plates, brackets, picture frames, aprons, trays, tapes, ropes, belts, bags, hoses and tubes. Examples of clothes are raincoats, mackintosh, rainwear sheets, children's leather coats, shoes, shoes covers, foot wears, gloves, ski wears, hats and sub-materials of hats. Examples of goods for vessel and package uses are food containers, cloth packaging goods, packing and packaging materials, cosmetics bottles, cosmetics containers, medicine bottles, food bottles, bottles for physics and chemistry, detergent bottles, containers, caps, food packs, laminate films, shrunk films for industrial use and wrapping films for business use. Examples of goods for medical use are a transfusion bag, a continuous ambulatory peritoneal dialysis bag, a bag for storing blood and a tube for medical use.

### EXAMPLES

The present invention is explained more specifically by the following Examples.

### [I] Evaluation of the Component (A) Thermoplastic Resin

### (1) Melt Flow Rate

Melt flow rate at 230° C. was measured under a load of 2.16 kg according to JIS-K-7210.

### (2) Die Swell Ratio

The thermoplastic resin was extruded under conditions of a barrel temperature of 190° C., a capillary diameter of 1 mm, a capillary length of 10 mm and a shear rate of 122 sec⁻¹ according to JIS-K-7199, and the die swell ratio (diameter of sample/diameter of capillary) was obtained.

### [II] Evaluation of the Component (B) Hydrogenated Vinyl Aromatic Compound-Conjugated Diene-Based Copolymer

### (1) Content of Vinyl Aromatic Compound

It was obtained by ¹H-NMR measurement method (frequency 90 MHz) using a carbon tetrachloride solution of the component (B).

### (2) Ratio of Hydrogenated Conjugated Diene Unit Having a Side Chain of 2 or More Carbon Atoms to a Total Hydrogenated Conjugated Diene Unit

It was obtained by Morero method using IR analysis of the component (B).

### (3) Hydrogenation Degree of Double Bond of Conjugated Diene Unit

It was obtained by ¹H-NMR measurement method (frequency 90 MHz) using a carbon tetrachloride solution of the component (B).

### (4) Melt Flow Rate

Melt flow rate at 230° C. was measured under a load of 2.16 kg according to JIS-K-7210.

Various properties of the thermoplastic elastomer composition mentioned in Examples and Comparative Examples were measured by the following methods.

### (1) Flowability

Melt flow rate at 230° C. was measured under a load of 2.16 kg according to JIS-K-7210.

### (2) Tensile Test

Tensile strength and elongation at break were measured according to JIS-K-6251 under conditions that a test piece (compression molded sheet having 2 mm thickness) having a shape according to dumbbell No.3 was used and a tensile rate was 200 mm/min.

### (3) Flexibility

Durometer Type A hardness was measured according to JIS-K-6253 using a sample containing four sheets piled of the above-mentioned test piece (compression molded sheet having 2 mm thickness).

### (4) Heat Resistance Test

In compliance with a normal oven method according to JIS-K-6257, a compression molded sheet having 1 mm thickness of the thermoplastic elastomer composition was heated at a test temperature of 110° C. for a test time of 100 hours to judge heat resistance. At this moment, the hanging test piece was hold as not to contact with each other and touch with any point of a wall inside the vessel of the test machine.

Judgment of heat resistance

◯: The compression molded sheet having 1 mm thickness was not deformed before and after the test.

X: The compression molded sheet having 1 mm thickness was deformed or melted, and therefore it could not keep its shape before the test.

### (5) Processability

The thermoplastic elastomer composition was extruded under conditions of a barrel temperature of 190° C., a capillary diameter of 2.095 mm, a capillary length of 8 mm and a shear rate of 132 sec⁻¹ according to JIS-K-7199; then a die swell ratio (diameter of sample/diameter of capillary) was measured; and then an extruded surface appearance of the obtained strand was judged. Incidentally, the larger the die swell ratio is, the better the shape retaining property under extruding of a molded article.

Judgment of extruded surface appearance

◯: The extruded surface appearance was smooth.

Δ: The extruded surface appearance was slightly rough.

X: The extruded surface appearance was not smooth, but rough.

### (6) Resistance to Whitening on Bending

The strand of the thermoplastic elastomer composition used for the above-mentioned evaluation of extrusion processability was bended, and its resistance to whitening on bending was judged.

◯: The bent part was not whitened.

X: The bent part was whitened.

### (7) Measurement of Expansion Ratio

The expansion ratio was defined as a value obtained by dividing thickness of the cellular layer of the obtained molded article by thickness (2 mm in case of Examples 5 and 6, and Comparative Example 3) of its non-cellular layer. By the way, the higher the expansion ratio is, the better sense of touch, light weight property and impact resilience are.

### (8) Appearance (Uniformity of Expansion Cell)

Observing a cellular layer by a visual inspection, a mark “◯” was assigned to a case wherein an expansion cell had uniformity, and a mark “X” was assigned to a case wherein an expansion cell did not have uniformity.

### Examples 1 to 4, and Comparative Example 1 and 2

The respective polypropylene-based resins mentioned in Table 1, the respective hydrogenated vinyl aromatic compound-conjugated diene-based copolymers mentioned in Table 2 and the ethylene-based polymer and the antioxidant mentioned in Table 3 were kneaded in a blending proportion mentioned in Table 3 for 5 minutes using a laboplastomil (manufactured by Toyo Seiki Co., Ltd. 65C150) under conditions that a kneading amount was 84 g, temperature was 180° C. and a rotating speed was 50 rpm to obtain a thermoplastic elastomer composition. Evaluation results of said composition are shown in Tables 3 and 4.

TABLE 1
Polypropylene-based resin

| | Unit | (A)-1 | (A)-2 | PP-1 |
|---|---|---|---|---|
| Melt flow rate | g/10 min. | 4.0 | 12.2 | 22.3 |
| Die swell ratio | | 2.31 | 3.46 | 1.43 |

(A)-1: Polypropylene resin
(A)-2: Propylene-ethylene copolymer resin (ethylene unit content: 4% by weight)
PP-1: Polypropylene-based resin not satisfying conditions required for (A)

TABLE 2
Hydrogenated vinyl aromatic compound-conjugated diene-based
copolymer

| | Unit | (B)-1 | (B)-2 | Copolymer-1 |
|---|---|---|---|---|
| (i) Content of vinyl | % by weight | 9 | 15 | 20 |
| aromatic compound unit | | | | |
| (ii) Ratio of | % | 80 | 80 | 42 |
| hydrogenated | | | | |
| conjugated diene unit | | | | |
| having a side chain of | | | | |
| 2 or more carbon atoms | | | | |
| to a total hydrogenated | | | | |
| conjugated diene unit | | | | |
| (iii) Hydrogenation | % | 98 | 98 | 98 |
| degree of double bond of | | | | |
| conjugated diene unit | | | | |
| Melt flow rate | g/10 min. | 10 | 30 | 13 |

(B)-1: Hydrogenated styrene-butadiene-styrene copolymer
(B)-2: Hydrogenated styrene-butadiene-styrene copolymer
Copolymer-1: Hydrogenated styrene-butadiene-styrene copolymer not satisfying conditions required for (B)

TABLE 3

| | | Example | | | |
|---|---|---|---|---|---|
| | Unit | 1 | 2 | 3 | 4 |
| Proportion | | | | | |
| (A)-1 | Part by weight | 25 | 25 | | 20 |
| (A)-2 | Part by weight | | | 25 | |
| (B)-1 | Part by weight | 75 | | 75 | 60 |
| (B)-2 | Part by weight | | 75 | | |
| (C)-1 | Part by weight | | | | 20 |
| Antioxidant | Part by weight | 0.1 | 0.1 | 0.1 | 0.1 |
| Property | | | | | |
| Melt flow rate | g/10 min. | 8.6 | 23.7 | 11.2 | 6.0 |
| Tensile strength | MPa | 10.1 | 11.9 | 10.6 | 7.5 |
| Elongation at | % | 1010 | 750 | 1080 | 1080 |
| break | | | | | |
| Hardness (Duro- | | 75 | 75 | 77 | 77 |
| meter hardness A) | | | | | |
| Heat resistance | | ◯ | ◯ | ◯ | ◯ |
| Die swell ratio | | 1.97 | 1.36 | 1.60 | 2.30 |
| Extruded surface | | Δ | ◯ | ◯ | ◯ |
| appearance | | | | | |
| Resistance to | | ◯ | ◯ | ◯ | ◯ |
| whitening on | | | | | |
| bending | | | | | |

(C)-1: Ethylene-1-butene copolymer (1-butene unit content: 17% by weight, density at 23° C. 0.885g/cm³, melt flow rate measured according to JIS-K-7210 at 190° C., under a load of 2.16 kg = 0.6 g/10 min.)
Antioxidant: IRGANOX 1010 (produced by Ciba Specialty Chemicals)

TABLE 4

Comparative
Example

| Proportion | Unit | 1 | 3 |
|---|---|---|---|
| (A)-1 | Part by weight | 25 | |
| PP-1 | Part by weight | | 25 |
| (B)-1 | Part by weight | | 75 |
| Copolymer-1 | Part by weight | 75 | |
| Antioxidant | Part by weight | 0.1 | 0.1 |
| Property | | | |
| Melt flow rate | g/10 min. | 13.1 | 9.6 |
| Tensile strength | MPa % | 12.4 | 10.7 |
| Elongation at beak | | 620 | 1070 |
| Hardness (Durometer | | 79 | 71 |
| hardness A) | | | |
| Heat resistance | | ◯ | ◯ |
| Die swell ratio | | 1.98 | 1.08 |
| Extruded surface | | ◯ | ◯ |
| appearance | | | |
| Resistance to | | X | ◯ |
| whitening on | | | |
| bending | | | |

Antioxidant: IRGANOX 1010 (produced by Ciba Specialty Chemicals)

### Example 5

A non-cellular material (0.5 mm thickness) comprising a polyolefin-based thermoplastic elastomer composition (manufactured by Sumitomo Chemical Co., Ltd. WT315), which contained polypropylene and an ethylene.α-olefin-based rubber, was arranged in a female mold, which was a disc mold having a 300 mm diameter; then a polypropylene resin-made core material (polypropylene resin AZ864E4 manufactured by Sumitomo Chemical Co., Ltd.) having 4 mm thickness was arranged in a core mold, which core material had a penetrating hole having a 10 mm diameter at a corresponding position to that of a path for a resin; and thereafter a distance between the core mold and the cavity mold was adjusted to be 8.5 mm (a clearance between the non-cellular material and the core material was 4 mm). Laminating and molding in one body of a multi-layer molded article comprising a non-cellular layer/cellular layer/core material layer were carried out according to a cavity slide method of an injection compression molding method using a thermoplastic elastomer composition between the non-cellular material and the core material, which composition was a mixture of 30 parts by weight of a pellet of a polypropylene resin (melt flow rate=4.0 g/10 min. and die swell ratio=2.3); 70 parts by weight of a pellet of a hydrogenated styrene-butadiene block copolymer (which was a hydrogenated styrene-butadiene-styrene block copolymer having a melt flow rate of 10 g/10 min.; a styrene unit content of 9% by weight; a ratio of a hydrogenated butadiene unit having a side chain (in this Example, it is an ethyl group) of 2 or more carbon atoms to a total hydrogenated butadiene unit of 80%; and a hydrogenation degree of a double bond of a butadiene unit of 98%); and 8 parts by weight of a powder-like blowing agent master batch MB3074 (manufacture by Sankyo Kasei Co. Ltd.) comprising 40% of an inorganic-based chemical blowing agent. In this Example, a method to expand at a time of cavity-sliding was used.

The above-mentioned thermoplastic elastomer composition containing the blowing agent was fed into an injection machine, and melt-kneaded at 200° C. After melt-kneading, said melt-kneaded material, whose amount resulted in a 2 mm thickness in a non-cellular state, was supplied between the core material and the non-cellular material (a clearance between the non-cellular material and the core material was 4 mm) arranged in the non-closed core mold and the cavity mold adjusted to 50° C.; then clamping was carried out under a bearing pressure of 5 MPa; then a distance between the core mold and the cavity mold was formed to 6.5 mm (thickness of said melt-kneaded material was 2 mm); and thereafter the non-cellular material, the melt-kneaded material and the core material were laminated and consolidated.

Next, pressure of 5 MPa was applied for 1.5 second after completion of forming by clamping; then said core mold and cavity mold were opened so as to make a distance of 13.5 mm between them; and said melt-kneaded material was expanded. After the expanded material was cooled in the mold for 60 seconds under this condition, the mold was opened and the multi-layer molded article comprising a non-cellular layer/cellular layer/core material layer was taken out. Evaluation results of this multi-layer molded article are shown in Table 1.

### Comparative Example 3

Examples 5 was repeated except that TUFTEC H1042 (which was a hydrogenated styrene-butadiene-styrene block copolymer having a melt flow rate of 30 g/10 min. measured at 230° C. under a load of 2.1 kg according to JIS-K-7210; a styrene unit content of 15% by weight; a ratio of a hydrogenated butadiene unit having a side chain of 2 or more carbon atoms to a total hydrogenated butadiene unit of 42%; and a hydrogenation degree of a double bond of a butadiene unit of 98%) manufactured by Asahi Kasei Corporation was used in place of the hydrogenated styrene-butadiene copolymer to produce a multi-layer molded article. Evaluation results of this multi-layer molded article are shown in Table 5.

### Example 6

Examples 5 was repeated except that there was used a thermoplastic elastomer composition, which was a mixture of 20 parts by weight of a polypropylene resin pellet used in Example 5, 60 parts by weight of a hydrogenated styrene-butadiene-based copolymer pellet used in Example 1, 20 parts by weight of a propylene-ethylene copolymer resin pellet (ethylene unit content=4% by weight, melt flow rate=12 g/10 min. and die swell ratio=3.5) and 8 parts by weight of a powder-like blowing agent master batch MB3074 (manufacture by Sankyo Kasei Co. Ltd.), to produce a multi-layer molded article. Evaluation results of the multi-layer molded articles are shown in Table 5.

In these Examples, multi-layer molded articles having a high expansion ratio, namely, having a superior light weight property, could be obtained by laminating and consolidating a non-cellular material comprising a thermoplastic elastomer composition and a resin core material using a cavity-slide method.

TABLE 5
Evaluation results of the multi-layer molded articles

| | Example 5 | Comparative Example 3 | Example 6 |
|---|---|---|---|
| Expansion ratio | 3.6 | 2.5 | 3.6 |
| Flexibility | 76 | 82 | 78 |
| Appearance | ◯ | X | ◯ |
| (uniformity of | | | |
| cell) | | | |

### Industrial Applicability

As explained above, the present invention can provide a thermoplastic elastomer composition, which is recyclable and can give an extrusion-molded article having superior processability, heat resistance, flexibility and resistance to whitening on bending; its extrusion molded article and expanded material; and a multi-layer molded article having a layer of said expanded material. Further, the thermoplastic elastomer composition and molded article in accordance with the present invention can be utilized for various uses by making use of the above-mentioned superior properties.

1. A thermoplastic elastomer composition comprising the following components (A) and (B), wherein a weight ratio of the component (A)/the component (B) is from 5/95 to 95/5:
(A): a thermoplastic resin, whose melt flow rate measured at 230° C. under a load of 2.16 kg according to JIS-K-7210 is 0.001 to 100 g/10 minutes, and whose die swell ratio measured according to JIS-K-7199 is 1.7 to 5.0, and
(B): a hydrogenated vinyl aromatic compound-conjugated diene-based copolymer satisfied with all the following conditions (i) to (iii):
(i) a content of a vinyl aromatic compound unit is not more than 50% by weight,
(ii) a ratio of a hydrogenated conjugated diene unit having a side chain of 2 or more carbon atoms contained in the hydrogenated vinyl aromatic compound-conjugated diene-based copolymer to a total hydrogenated conjugated diene unit contained therein is not less than 60%, and
(iii) at least 80% of a double bond of a conjugated diene unit contained in the hydrogenated vinyl aromatic compound-conjugated diene-based copolymer is hydrogenated.

2. The thermoplastic elastomer composition according to claim 1, wherein the component (A) comprises a polypropylene-based resin.

3. The thermoplastic elastomer composition according to claim 1, wherein the component (B) comprises a hydrogenated styrene-butadiene copolymer.

4. The thermoplastic elastomer composition according to claim 1, wherein the weight ratio of the component (A)/the component (B) is from 15/85 to 45/55.

5. An extrusion molded article obtained by extrusion molding the thermoplastic elastomer composition mentioned in claim 1.

6. A multi-layer molded article having a cellular layer comprising the thermoplastic elastomer composition mentioned in claim 1.

7. The multi-layer molded article according to claim 6, wherein the component (A) comprises a polypropylene-based resin.

8. A multi-layer molded article containing a cellular layer comprising the thermoplastic elastomer composition mentioned in claim 1, and a non-cellular layer.

9. The multi-layer molded article according to claim 8, wherein the component (A) comprises a polypropylene-based resin.

10. The multi-layer molded article according to claim 6 or claim 7, wherein a non-cellular layer comprising at least one component selected from the following components (a) to (c) is contained:
(a) a polyolefin-based thermoplastic elastomer composition,
(b) a polyolefin-based resin, and
(c) a cross-linked polyolefin-based resin.

11. The multi-layer molded article according to any one of claims 6 to 10, wherein a core material is laminated on the cellular layer.

12. The multi-layer molded article according to claim 11, wherein the core material comprises a polypropylene-based resin.

13. The multi-layer molded article according to any one of claims 6 to 12, wherein the cellular layer is obtained by an injection molding method.
